(19) United States
(12) Patent Application Publication
(10) Pub. No.: US 2018/0152346 A1
(43) Pub. Date: May 31, 2018

(54) INFORMATION PROCESSING DEVICE, COMMUNICATION CONTROL METHOD, AND COMPUTER-READABLE RECORDING MEDIUM

(71) Applicant: FUJITSU LIMITED, Kawasaki-shi (JP)

(72) Inventors: Yuuki Tanabe, Numazu (JP); Yuusuke Shimada, Numazu (JP); Kazuhiro MIYASHITA, Yokohama (JP)

(73) Assignee: FUJITSU LIMITED, Kawasaki-shi (JP)

(21) Appl. No.: 15/787,802

(22) Filed: Oct. 19, 2017

(30) Foreign Application Priority Data
Nov. 29, 2016 (JP) 2016-231796

(51) Int. Cl. H04L 12/24

(52) U.S. Cl. CPC H04L 41/0813; H04L 41/0863; H04L 41/0859

(57) ABSTRACT

An overall management device decides network information on an internet GW router and a router. A cloud environment management device performs a first setting on the internet GW router based on the network information decided by the overall management device and cancels, if the first setting has failed, the first setting performed on the internet GW router. A local connection environment management device performs a second setting on the router based on the network information decided by the overall management device and cancels, if the cloud environment management device fails the first setting, the second setting performed on the router.

### CROSS-REFERENCE TO RELATED APPLICATION

This application is based upon and claims the benefit of priority of the prior Japanese Patent Application No. 2016-231796, filed on Nov. 29, 2016, the entire contents of which are incorporated herein by reference.

### FIELD

The embodiments discussed herein are related to an information processing device, a communication control method, and a computer-readable recording medium.

### BACKGROUND

When providing a cloud service, such as Infrastructure as a Service (IaaS), or the like, in a data center, there is a provided service that performs intranet connection with a customer location by using a private line. In a system that provides such a service, as a system that provides the cloud service, virtual servers and virtual routers are often arranged. Then, physical routers connected to both virtual servers and virtual routers and physical routers connected to a system at the customer location are connected by using a Multi-Protocol Label Switching (MPLS), or the like. In this way, a system in which the cloud service provided by the virtual servers in the system that is used in the system at the customer location is constructed.

In such a system, in some cases, an administrator in a cloud service providing environment in a data center is different from an administrator in an environment for connecting to a customer location. Thus, the setting of the physical router on the cloud service side is performed by using the following procedure.

First, an administrator who receives an application of a cloud service receives, from a user, a connection application between the system constructed in the cloud computing and the system at the customer location. Then, the administrator who received the application decides, based on the application from the user, management information including a Virtual Local Area Network Identifier (VLAN ID), a Local Area Network (LAN) address, and a Virtual Routing and Forwarding (VRF) identifier. Then, the administrator who has received the application notifies the administrator in each of the environments of the decided management information. The administrator in each of the environments designs, based on the notified management information, the set content of the physical router and creates the setup steps. Then, the administrator in each of the environments reviews and checks that no error is present in the steps. Then, the administrator in each of the environments sets the physical router in accordance with the created steps. Thereafter, the administrator in each of the environments notifies the administrator who has received the application that the setting has been completed.

In this way, the administrator in each of the environments independently works the setting of the physical router. Thus, if a setting of the physical router has failed in one of the environments, there may be a case in which the set states of both the physical routers temporarily become inconsistent.

Furthermore, as a technology that synchronizes settings of a plurality of information communication apparatuses, there is a conventional technology that automatically synchronizes pieces of setting information in distributed servers operated via a load balancer. Furthermore, there is a conventional technology that stores, if a plurality of settings is performed on network devices, updated generation information and maintains, when a certain setting is restored, another setting by using the generation information. Furthermore, there is a conventional technology that constructs and manages a network environment in which physical information processing devices and virtual information processing devices are present in a mixed manner.

Patent Document 1: Japanese Laid-open Patent Publication No. 2006-209490

Patent Document 2: Japanese Laid-open Patent Publication No. 2015-142167

Patent Document 3: International Publication Pamphlet No. WO 2014/128948

However, if an inconsistent state occurs between the set states of both the physical routers due to a failure in the setting, because a recovery operation of the physical router in which the setting has failed is manually performed by the administrator in each of the environments, the damage may possibly be increased due to an error in a recovery procedure or an error in an operation procedure. For example, it is conceivable that, if a setting is not accidentally canceled, a useless packet may possibly be sent and the performance of the physical router is degraded and thus the load of the network is increased. Furthermore, error logs are continuously output from the physical router in which communication has failed and, if another serious failure occurs, it may possibly be difficult to specify the error log of the serious failure. In this way, if the damage of the failure to set the environment is increased, the quality of the service may possibly be decreased.

Furthermore, in the conventional technology that automatically synchronizes the pieces of the setting information in distributed servers, it is difficult to restore the physical routers. Furthermore, even if the conventional technology that maintains another setting by using the generation information is used, it is difficult to dissolve the inconsistency between the physical routers. Furthermore, even if the conventional technology that uses the system in which physical information processing devices and virtual information processing devices are present in a mixed manner is used, it is difficult to restore the physical router. Because of these, it is difficult to improve the quality of the service provided via the plurality of physical routers even if any one of the conventional technologies is used.

### SUMMARY

According to an aspect of an embodiment, an information processing device includes: a first communication apparatus and a second communication apparatus; a management unit that decides communication setting information on each of the first communication apparatus and the second communication apparatus; a first setting unit that performs a first setting on the first communication apparatus based on the communication setting information decided by the management unit and that cancels, when the first setting has failed, the first setting performed on the first communication apparatus; and a second setting unit that performs a second setting on the second communication apparatus based on the communication setting information decided by the management unit and that cancels, when the first setting unit has failed the first setting, the second setting performed on the second communication apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a network configuration of a data center according to an embodiment;

FIG. 2 is a schematic diagram illustrating the setting of a physical router;

FIG. 3 is block diagrams of an overall management device, a cloud environment management device, and a local connection environment management device;

FIG. 4 is a diagram illustrating an example of controller information;

FIG. 5 is a diagram illustrating an example of resource management information;

FIG. 6 is a diagram illustrating an example of VRF identifier information;

FIG. 7 is a diagram illustrating an example of VLAN identifier information;

FIG. 8 is a diagram illustrating an example of LAN address information;

FIG. 9 is a diagram illustrating an example of virtual router management information;

FIG. 10 is a diagram illustrating an example of physical router connection information;

FIG. 11 is a diagram illustrating an example of physical router information;

FIG. 12 is a diagram illustrating an example of definition creation information;

FIG. 13 is a diagram illustrating an example of set state information;

FIG. 14 is a diagram illustrating an example of policy information;

FIG. 15 is a block diagram illustrating an internet GW router;

FIG. 16 is a flowchart of a process performed by the overall management device at the time of setting the physical router;

FIG. 17 is a flowchart of a process performed by the cloud environment management device at the time of setting the physical router;

FIG. 18 is a flowchart of a process performed by the local connection environment management device at the time of setting the physical router; and

FIG. 19 is a diagram illustrating a hardware configuration of an information processing device used as the overall management device, the cloud environment management device, and the local connection environment management device.

### DESCRIPTION OF EMBODIMENTS

Preferred embodiments of the present invention will be explained with reference to accompanying drawings. Furthermore, the information processing device, the communication control method, and the communication control program disclosed in the present invention are not limited to the embodiments described below.

### Embodiment

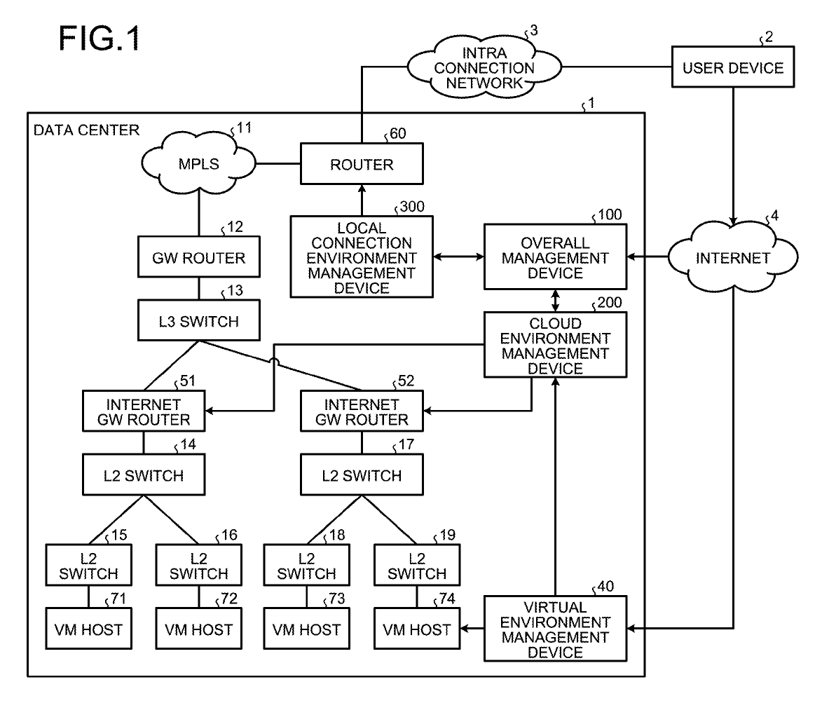

FIG. 1 is a diagram illustrating a network configuration of a data center according to an embodiment. A data center 1 according to the embodiment includes an overall management device 100, a cloud environment management device 200, and a local connection environment management device 300. Furthermore, the data center 1 includes a virtual environment management device 40, internet gateway (GW) routers 51 and 52, and a router 60. Furthermore, the data center 1 includes an MPLS 11, a GW router 12, a Layer (L) 3 switch 13, L2 switches 14 to 19, and virtual machine (VM) hosts 71 to 74. The data center 1 provides, for example, an IaaS cloud service.

The router 60 is a physical router used to connect to an intranet at the customer location. The router 60 is connected to a user device 2 via an intra connection network 3 that is connected to the intranet at the customer location. Furthermore, the router 60 is connected to the GW router 12 via the MPLS 11. The router 60 mentioned here corresponds to an example of a “first communication apparatus” or a “second communication apparatus”.

The MPLS 11 is a network using the MPLS. The GW router 12 is a gateway for connecting the internet GW routers 51 and 52 to the MPLS 11. The L3 switch 13 is a switch for collectively connecting the paths of the internet GW routers 51 and 52 to the GW router 12.

The internet GW routers 51 and 52 are physical routers that become the gateway for connecting the VM hosts 71 to 74 to the Internet.

The internet GW router 51 is connected to the VM host 71 or 72 via the L2 switches 14 to 16. Furthermore, the internet GW router 51 is connected to the L3 switch 13. Furthermore, the internet GW router 52 is connected to the VM host 73 or 74 via the L2 switches 17 to 19. Furthermore, the internet GW router 52 is connected to the L3 switch 13. The internet GW routers 51 and 52 have the same function; therefore, when both are not distinguished, the internet GW routers 51 and 52 are referred to as an “internet GW router 50”.

If the router 60 is conceived as the “first communication apparatus”, the internet GW router 50 corresponds to an example of the “second communication apparatus”. Furthermore, if the router 60 is conceived as the “second communication apparatus”, the internet GW router 50 corresponds to an example of the “first communication apparatus”.

The L2 switches 14 to 19 are switches that are used to connect each of the VM hosts 71 to 74 to the internet GW router 51 or 52.

The VM hosts 71 to 74 are physical servers. The VM hosts 71 to 74 are connected to the L2 switches 15 to 19, respectively. The VM hosts 71 to 74 operate virtual servers and virtual routers created by the virtual environment management device 40. Then, the VM hosts 71 to 74 provide the service provided by the virtual servers to the user device 2. When the VM hosts 71 to 74 are not distinguished, the VM hosts 71 to 74 are referred to as a “VM host 70”.

The virtual environment management device 40 receives an input of information, such as the domain ID, the virtual router ID to be connected, or the like designated by a user from the user device 2 via the Internet 4. Then, the virtual environment management device 40 creates virtual servers and virtual routers in the VM hosts 71 to 74 by using the information input from the user device 2. The virtual environment management device 40 is an information processing device in which, for example, OpenStack (registered trademark) is operated.

The overall management device 100 acquires the domain ID and the virtual router ID to be connected that are input from the user device 2. Then, the overall management device 100 allows the cloud environment management device 200 and the local connection environment management device 300 to set the internet GW router 50 and the router 60. The cloud environment management device 200 sets the internet GW router 50 by using the information that is input from the overall management device 100. The local connection environment management device 300 sets the router 60 by using the information that is input from the overall management device 100.

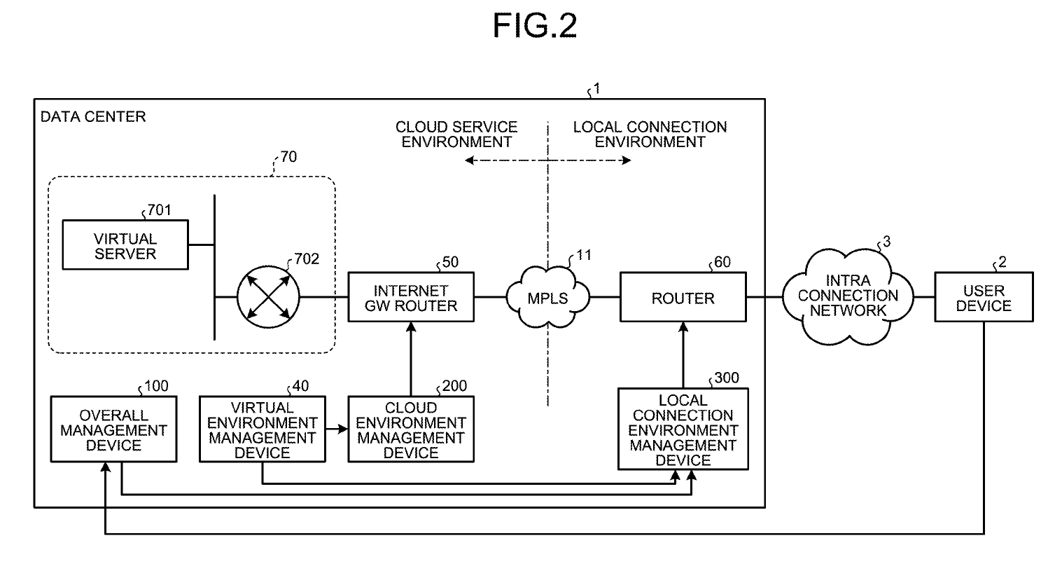

FIG. 2 is a schematic diagram illustrating the setting of the physical router. FIG. 2 extracts and illustrates the environment that is used to set the internet GW router 50 and the router 60. The environment that has the VM host 70 and the internet GW router 50 are in a cloud service environment when the MPLS 11 in the data center 1 is used as a boundary. Furthermore, the environment that has the router 60 is a local connection environment when the MPLS 11 in the data center 1 is used as a boundary.

The VM host 70 includes a virtual server 701 and a virtual router 702. The cloud environment management device 200 manages the internet GW router 50 that is a physical router arranged in the cloud service environment. Furthermore, the local connection environment management device 300 manages the router 60 that is the physical router arranged in the local connection environment.

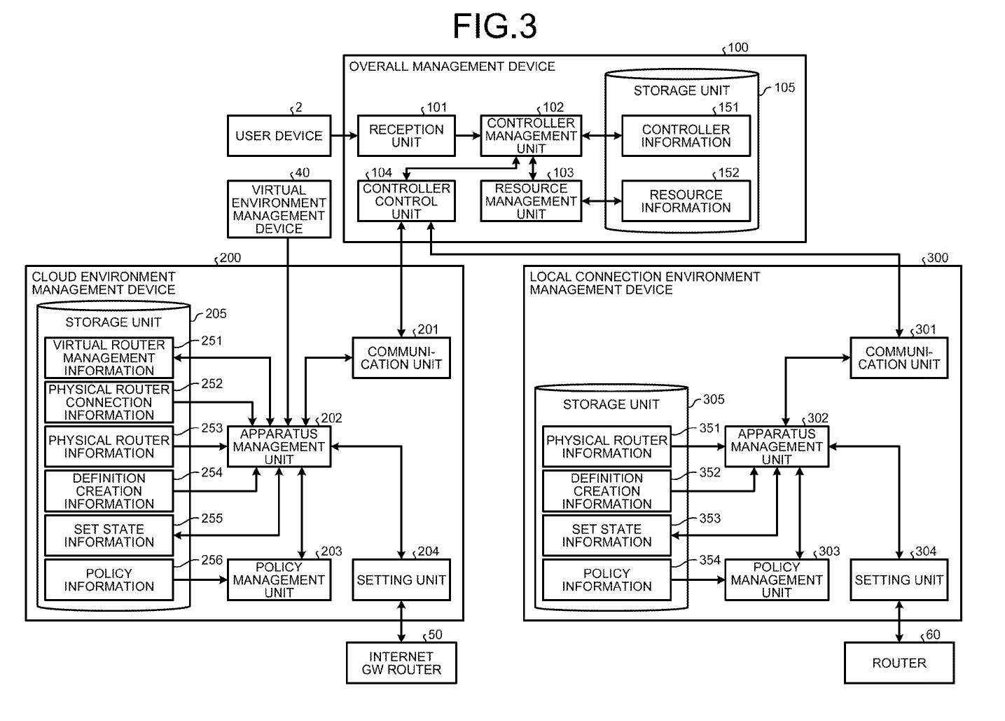

In the following, the setting of the physical router performed by the overall management device 100, the cloud environment management device 200, and the local connection environment management device 300 will be described in detail with reference to FIG. 3. FIG. 3 is block diagrams of an overall management device, a cloud environment management device, and a local connection environment management device.

The overall management device 100 includes a reception unit 101, a controller management unit 102, a resource management unit 103, a controller control unit 104, and a storage unit 105. The overall management device 100 mentioned here corresponds to an example of a “management unit”.

The storage unit 105 previously includes controller information 151 and resource information 152. The controller information 151 stores therein network information on the cloud environment management device 200 and the local connection environment management device 300. The resource information 152 stores therein network information that is used for communication with the virtual server 701.

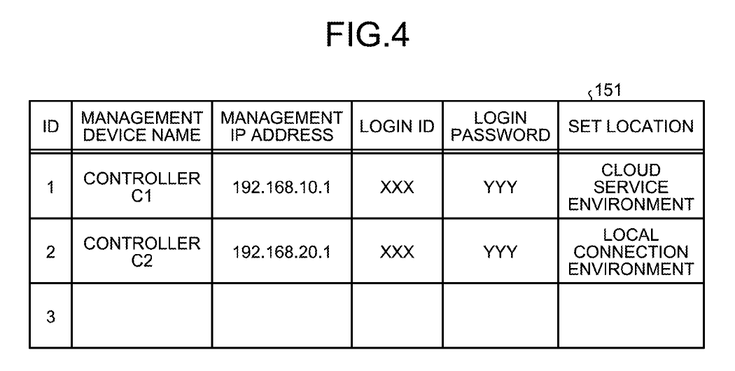

FIG. 4 is a diagram illustrating an example of the controller information. The ID is an identifier allocated to the cloud environment management device 200 and the local connection environment management device 300. The management device name is the identification name of each of the cloud environment management device 200 and the local connection environment management device 300. The management Internet Protocol (IP) address is the IP address used to manage the cloud environment management device 200 and the local connection environment management device 300. The login ID is an identifier for logging in to the cloud environment management device 200 and the local connection environment management device 300. Furthermore, the login password is a password used to log in the cloud environment management device 200 and the local connection environment management device 300. The set location is the location in which the cloud environment management device 200 and the local connection environment management device 300 are set.

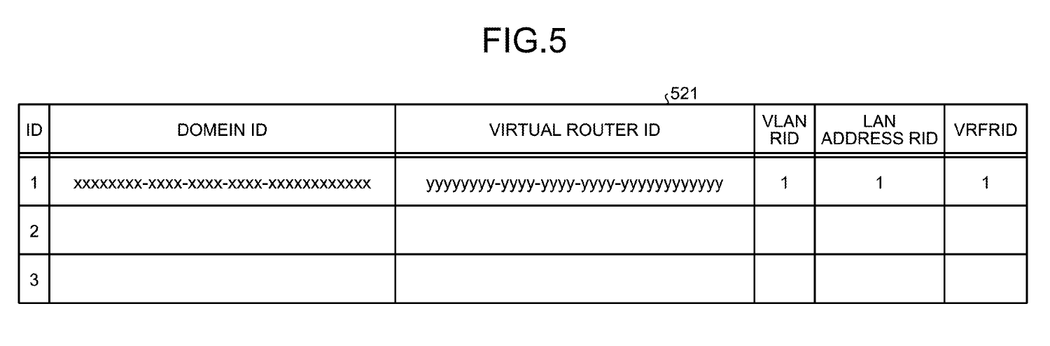

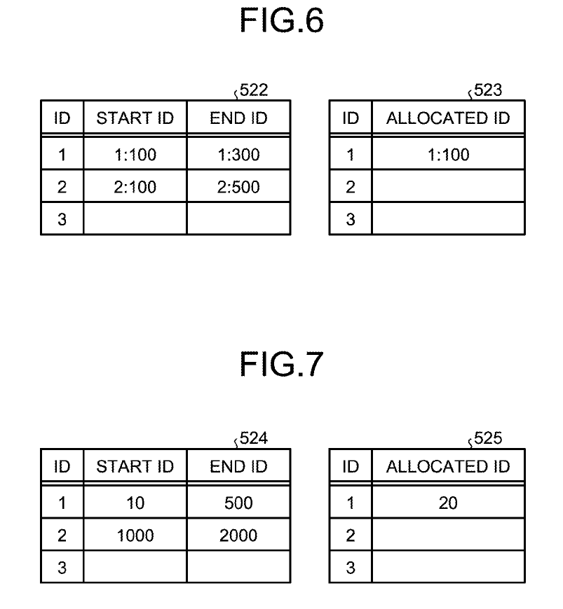

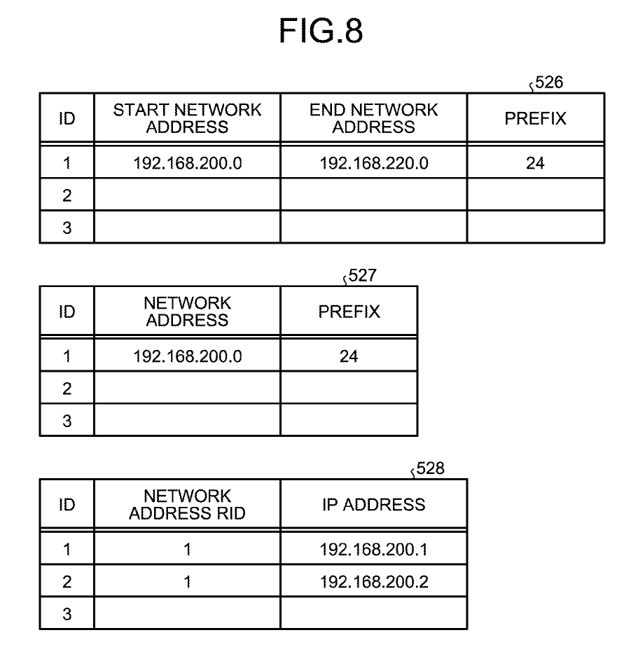

The resource information 152 includes each of the tables illustrated in FIGS. 5 to 8. FIG. 5 is a diagram illustrating an example of resource management information. FIG. 6 is a diagram illustrating an example of virtual routing and forwarding (VRF) identifier information. FIG. 7 is a diagram illustrating an example of virtual local area network (VLAN) identifier information. FIG. 8 is a diagram illustrating an example of local area network (LAN) address information.

Resource management information 521 includes, as illustrated in FIG. 5, the ID, the domain ID, the virtual router ID, the VLAN relative identifier (RID), the LAN address RID, and the VRF RID. In VRF identifier pool information 522, as illustrated in FIG. 6, the VRF identifiers that can be used are registered. Furthermore, in allocation VRF identifier information 523, already used VRF identifiers are registered. In VLAN pool information 524, as illustrated in FIG. 7, the VLAN identifiers that can be used are registered. Furthermore, in allocation VLAN information 525, already used VLAN identifiers are registered. In LAN address pool information 526, as illustrated in FIG. 8, the network addresses that can be used and prefix information thereof are registered. Furthermore, in allocation network address information 527, information on the already used network addresses is registered. Furthermore, in allocation LAN address information 528, information on the already used IP addresses and the network address RID associated with the corresponding IP addresses are registered.

A description will be continued by referring back to FIG. 3. The reception unit 101 receives an input of the information on the domain ID of the user that is input from the user device 2 and the virtual router ID to be connected. Then, the reception unit 101 outputs, to the controller management unit 102, the information on the domain ID of the user and the virtual router ID that is to be connected.

The controller management unit 102 receives an input of the information on the domain ID and the virtual router ID from the reception unit 101. Then, the controller management unit 102 notifies the resource management unit 103 of the domain ID and the virtual router ID and then instructs the resource management unit 103 to allocate the resources. Then, the controller management unit 102 receives the input of the VLAN ID, the LAN address, and the VRF identifier from the resource management unit 103. Furthermore, the controller management unit 102 acquires, from the controller information 151, the network information on the cloud environment management device 200 and the local connection environment management device 300 that are allowed to set the physical router. Then, the controller management unit 102 notifies the controller control unit 104 of the network information on the cloud environment management device 200 and the local connection environment management device 300. Then, the controller management unit 102 instructs the controller control unit 104 to notify the cloud environment management device 200 of the domain ID, the virtual router ID, the VLAN ID, the LAN address, and the VRF identifier. Furthermore, the controller management unit 102 instructs the controller control unit 104 to notify the local connection environment management device 300 of the VLAN ID, the LAN address, and the VRF identifier. The VLAN ID, the LAN address, and the VRF identifier mentioned here are an example of “communication setting information”.

Then, if the setting of both the internet GW router 50 and the router 60 performed by the cloud environment management device 200 and the local connection environment management device 300 has normally been completed, the controller management unit 102 receives a notification of the completion of the normal setting from the controller control unit 104. Then, the controller management unit 102 ends the process of setting the internet GW router 50 and the router 60.

In contrast, if the setting has failed one of the internet GW router 50 and the router 60, the controller management unit 102 receives a notification of a failure in the setting from the controller control unit 104. Then, the controller management unit 102 specifies the VLAN ID, the LAN address, and the VRF identifier that were used for the failed setting. Then, the controller management unit 102 notifies the controller control unit 104 of the VLAN ID, the LAN address, and the VRF identifier that were used for the failed setting.

The resource management unit 103 receives, from the controller management unit 102, an instruction to allocate the resource by using the domain ID and the virtual router ID. Then, the resource management unit 103 registers the acquired domain ID and the virtual router ID in the resource management information 521 included in the resource information 152.

Then, the resource management unit 103 selects, from the VRF identifier pool information 522, the VRF identifier other than the VRF identifiers registered in the allocation VRF identifier information 523. Then, the resource management unit 103 registers the selected VRF identifier in the allocation VRF identifier information 523. Then, the resource management unit 103 acquires the ID associated with the VRF identifier registered in the allocation VRF identifier information 523. Then, the resource management unit 103 registers the acquired ID as the VRF RID in the resource management information 521 included in the resource information 152.

Then, the resource management unit 103 selects the VLAN identifier other than the VLAN identifiers registered in the allocation VLAN information 525 from the VLAN pool information 524. Then, the resource management unit 103 registers the selected VLAN identifier in the allocation VLAN information 525. Then, the resource management unit 103 acquires the ID associated with the VLAN identifier registered in the allocation VLAN information 525. Thereafter, the resource management unit 103 registers the acquired ID as the VLAN RID in the resource management information 521 included in the resource information 152.

Then, the resource management unit 103 selects, from the LAN address pool information 526, the network address other than the network addresses registered in the allocation network address information 527 and the prefix thereof. Then, the resource management unit 103 registers the selected network address and the prefix in the allocation network address information 527. Furthermore, when registering the information in the allocation network address information 527, the resource management unit 103 allocates the ID that becomes the network address RID to each of the network addresses. Then, the resource management unit 103 selects the IP addresses having the prefix portion of the network addresses registered in the allocation network address information 527 by the number corresponding to the number of the cloud environment management devices 200 and the local connection environment management devices 300. Furthermore, the resource management unit 103 acquires the network address RID common to each of the IP addresses from the allocation network address information 527. Thereafter, the resource management unit 103 registers the selected IP addresses and the network address RIDs thereof in the allocation LAN address information 528. Furthermore, the resource management unit 103 registers, as the LAN address RID, the network address RID registered in the allocation network address information 527 in the resource management information 521 included in the resource information 152.

Then, the resource management unit 103 outputs the VLAN RID, the LAN address RID, and the VRF RID registered in the resource management information 521, to the controller management unit 102 as the VLAN ID, the LAN address, and the VRF identifier that are used to set the physical router.

The controller control unit 104 receives a notification of the network information on the cloud environment management device 200 and the local connection environment management device 300 from the controller management unit 102. Furthermore, the controller control unit 104 receives, from the controller management unit 102, an instruction to notify the cloud environment management device 200 and the local connection environment management device 300 of the domain ID, the virtual router ID, the VLAN ID, the LAN address, and the VRF identifier. The controller control unit 104 notifies, by using the notified network information, the cloud environment management device 200 and the local connection environment management device 300 of the domain ID, the virtual router ID, the VLAN ID, the LAN address, and the VRF identifier.

Then, the controller control unit 104 receives a notification of the setting result of the internet GW router 50 from the cloud environment management device 200. Furthermore, the controller control unit 104 receives a notification of the setting result of the router 60 from the local connection environment management device 300.

If the setting of both the internet GW router 50 and the router 60 has been normally completed, the controller control unit 104 notifies the controller management unit 102 of the completion of the normal setting.

In contrast, if the setting has been failed in one of the internet GW router 50 and the router 60, the controller control unit 104 notifies the controller management unit 102 of the failure in the setting. Then, the controller control unit 104 acquires the VLAN ID, the LAN address, and the VRF identifier that were used for the failed setting from the controller management unit 102. Then, the controller control unit 104 sends the VLAN ID, the LAN address, and the VRF identifier to the device arranged on the side in which the setting has been normally completed and instructs the device to release the setting.

The cloud environment management device 200 includes a communication unit 201, an apparatus management unit 202, a policy management unit 203, a setting unit 204, and a storage unit 205. The cloud environment management device 200 mentioned here corresponds to an example of a “first setting unit” or a “second setting unit”.

The storage unit 205 includes virtual router management information 251, physical router connection information 252, physical router information 253, definition creation information 254, set state information 255, and policy information 256.

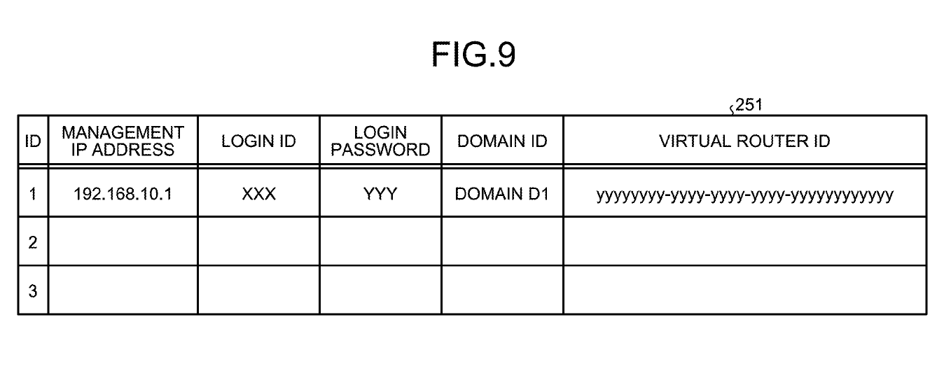

FIG. 9 is a diagram illustrating an example of virtual router management information. In the virtual router management information 251, the management IP address, the login ID, the login password, the domain ID, and the virtual router ID are registered. The management IP address is the IP address that is used to manage the VM host 70 in which the virtual router 702 having the virtual router ID is arranged. The login ID and the login password are information used to log in the VM host 70 that has the management IP address. However, in the embodiment, the virtual router management information 251 is created after the start of the setting process on the internet GW router 50 by the apparatus management unit 202, which will be described later, and is created in the storage unit 205.

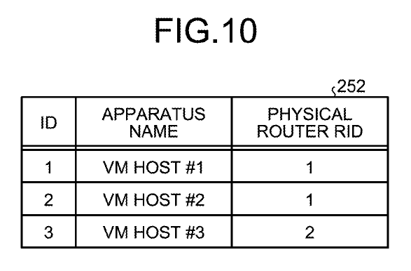

FIG. 10 is a diagram illustrating an example of physical router connection information. In the physical router connection information 252, the apparatus name of each of the VM hosts 70 are associated with the RID of the internet GW router 50 connected to the VM host 70 and are registered.

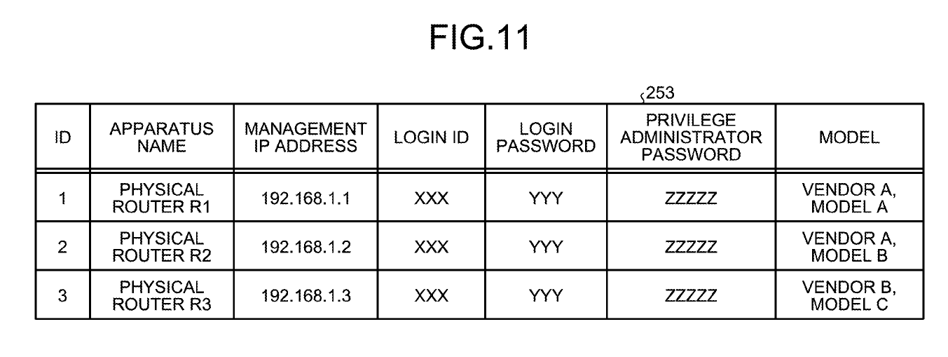

FIG. 11 is a diagram illustrating an example of physical router information. The ID of the physical router information 253 is associated with the RID of the internet GW router 50. Furthermore, in the physical router information 253, the management IP address of each of the internet GW routers 50, the login ID, the login password, the privilege administrator password, and the model are registered by being associated with the apparatus name given to each of the internet GW routers 50. In the field of the model, identification information indicating the manufacturer and the model is registered.

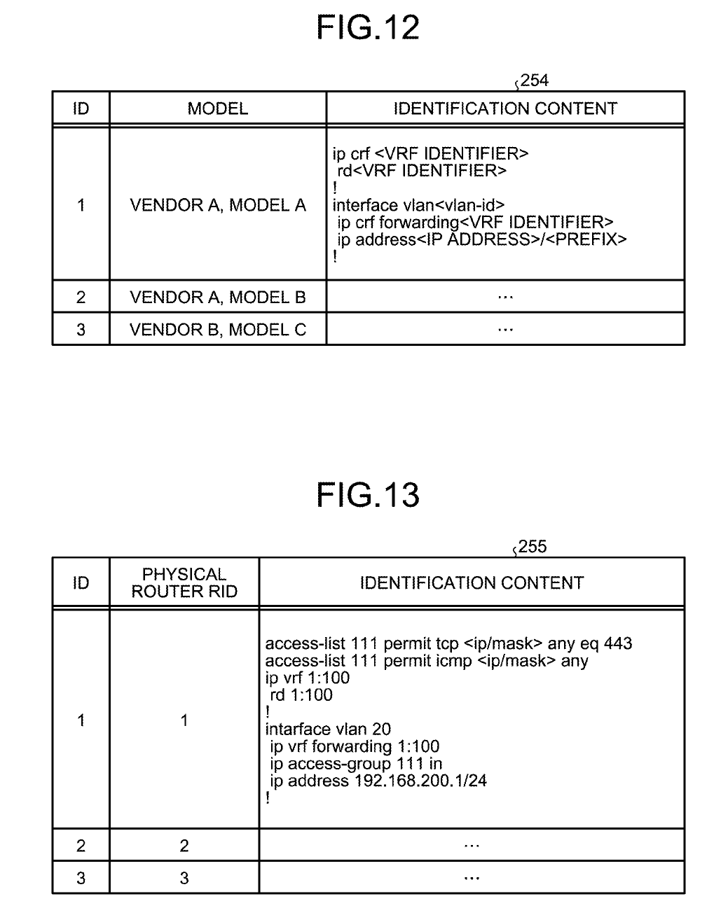

FIG. 12 is a diagram illustrating an example of definition creation information. In the definition creation information 254, the format that is used to create the definition information that is used to set the physical router in accordance with each model of the internet GW router 50 is registered.

FIG. 13 is a diagram illustrating an example of set state information. In the set state information 255, the content of the definition information created in order to set the internet GW router 50 is registered.

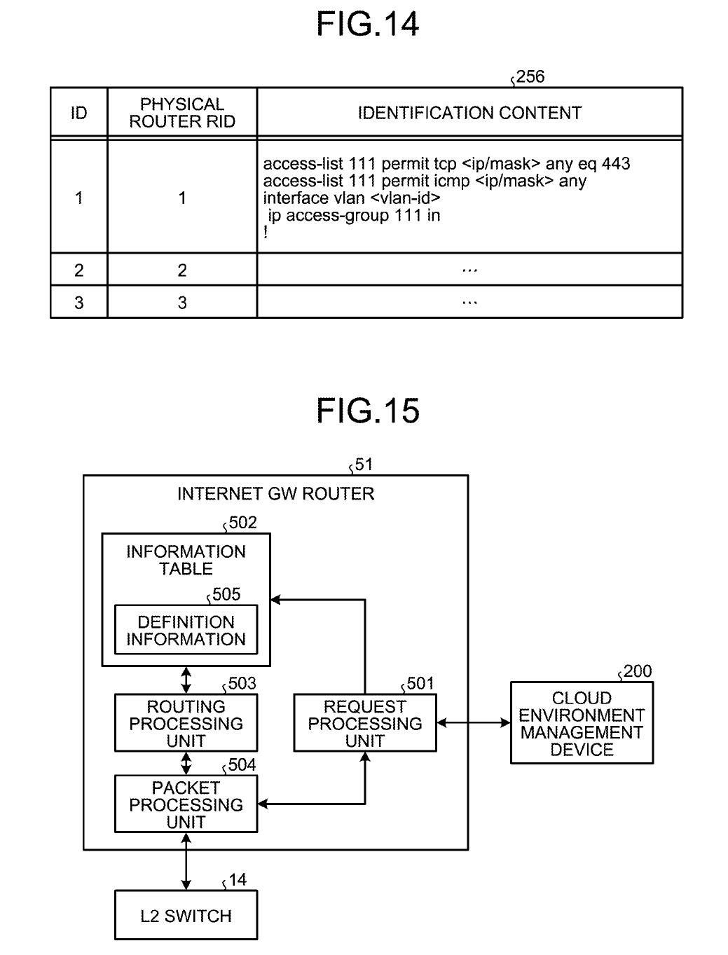

FIG. 14 is a diagram illustrating an example of policy information. In the policy information 256, the definition information that is used to set the security policy that is previously determined for each of the internet GW routers 50 is registered.

The communication unit 201 receives the domain ID, the virtual router ID, the VLAN ID, the LAN address, and the VRF identifier from the controller control unit 104 in the overall management device 100. Then, the communication unit 201 outputs the received domain ID, the virtual router ID, the VLAN ID, the LAN address, and the VRF identifier to the apparatus management unit 202.

Then, the communication unit 201 receives an input of the execution result of the setting from the apparatus management unit 202. Then, the communication unit 201 sends the execution result of the setting to the controller control unit 104 in the overall management device 100.

If the setting of the internet GW router 50 has normally completed and if the setting of the router 60 performed by the local connection environment management device 300 has failed, the communication unit 201 receives an instruction to release the setting together with the VLAN ID, the LAN address, and the VRF identifier from the controller control unit 104. Then, the communication unit 201 outputs the instruction to release the setting together with the VLAN ID, the LAN address, and the VRF identifier to the apparatus management unit 202. Thereafter, the communication unit 201 receives a notification of the completion of the setting release from the apparatus management unit 202. Then, the communication unit 201 sends the completion of the setting release to the controller control unit 104.

Furthermore, in also the case of a failure in the setting of the internet GW router 50, the communication unit 201 receives the notification of the completion of the setting release from the apparatus management unit 202. Then, the communication unit 201 sends the completion of the setting release to the controller control unit 104.

The apparatus management unit 202 receives an input of the domain ID, the virtual router ID, the VLAN ID, the LAN address, and the VRF identifier from the communication unit 201. Then, the apparatus management unit 202 acquires the information on the VM hosts 70 in each of which the virtual router 702 is arranged from the virtual environment management device 40 and creates the virtual router management information 251. Then, the apparatus management unit 202 acquires, from the virtual router management information 251 illustrated in FIG. 9, management IP address, the login ID, and the login password of the VM host 70 associated with the domain ID and the virtual router ID.

Then, the apparatus management unit 202 specifies the apparatus name of the VM host 70 from the management IP address, the login ID, and the login password. Then, the apparatus management unit 202 acquires, from the physical router connection information 252 illustrated in FIG. 10, the RID of the internet GW router 50 connected to the VM host 70 that has the specified apparatus name. The apparatus management unit 202 specifies that the internet GW router 50 having the acquired RID is the internet GW router 50 that performs the setting.

Then, the apparatus management unit 202 acquires, from the physical router information 253 illustrated in FIG. 11, the information on the model associated with the RID of the internet GW router 50 that performs the setting. Then, the apparatus management unit 202 acquires, from the definition creation information 254 illustrated in FIG. 12, the definition content associated with the information on the acquired model.

Then, the apparatus management unit 202 notifies the policy management unit 203 of the RID of the internet GW router 50 that performs the setting and then requests the policy management unit 203 to acquire the definition content of the policy that is set in the internet GW router 50 that performs the setting. Thereafter, the apparatus management unit 202 receives, from the policy management unit 203, an input of the definition content of the policy that is set in the internet GW router 50 that performs the setting.

Then, by using the definition content that is in accordance with the model of the internet GW router 50 that performs the setting and the definition content of the policy and by using the VLAN ID, the LAN address, and the VRF identifier, the apparatus management unit 202 creates the definition information that is used to perform the setting. Thereafter, the apparatus management unit 202 acquires, from the physical router information 253 illustrated in FIG. 11, the management IP address, the login ID, the login password, and the privilege administrator password of the internet GW router 50 that performs the setting. Thereafter, the apparatus management unit 202 sends, to the setting unit 204, the management IP address, the login ID, the login password, the privilege administrator password of the internet GW router 50 that performs the setting and the created definition information. Then, the apparatus management unit 202 instructs the setting unit 204 to perform the setting of the internet GW router 50.

Thereafter, the apparatus management unit 202 receives a notification of the execution result of the setting from the setting unit 204. If the notification of the completion of the normal setting is received from the setting unit 204, the apparatus management unit 202 notifies the communication unit 201 of the completion of the normal setting. Furthermore, the apparatus management unit 202 associates the setting information with the RID of the internet GW router 50 that performed the setting and registers the associated setting information in the set state information 255 illustrated in FIG. 13.

At this time, if the setting of the router 60 performed by the local connection environment management device 300 has failed, after having notified the communication unit 201 of the completion of the normal setting, the apparatus management unit 202 receives, from the communication unit 201, an input of an instruction to release the setting together with the VLAN ID, the LAN address, and the VRF identifier. In this case, the apparatus management unit 202 specifies, from the definition content registered in the set state information 255, the definition content associated with the acquired VLAN ID, the LAN address, and the VRF identifier.

Furthermore, the apparatus management unit 202 determines whether the common definition that is also used for the communication with another user is present in the specified definition content. The common definition mentioned here is, for example, the setting related to security, such as the setting of a firewall, the setting of separating communication in the MPLS 11, or the like. The common definition that is also used for the communication with respect to another user corresponds to a “common part of another setting”.

If the common definition used for the communication with the other user is present in the specified definition content, the apparatus management unit 202 creates definition information that cancels the definition dependent on the user except for the common definition from the definition content. In contrast, if the common definition used for the communication with the other user is not present in the specified definition content, the apparatus management unit 202 creates the definition information that cancels the set content including the common definition and the definition dependent on the user.

Furthermore, the apparatus management unit 202 acquires the RID of the internet GW router 50 from the set state information 255. Then, the apparatus management unit 202 acquires, from the physical router information 253, the management IP address, the login ID, the login password, and the privilege administrator password of the internet GW router 50 that has the acquired RID.

Then, the apparatus management unit 202 sends, to the setting unit 204, the management IP address, the login ID, the login password, the privilege administrator password of the internet GW router 50 and the created definition information. Thereafter, the apparatus management unit 202 receives, from the setting unit 204, a notification of the completion of the setting release. Then, the apparatus management unit 202 outputs the completion of the setting release to the communication unit 201.

In contrast, if a notification of a failure in the setting is received from the setting unit 204, the apparatus management unit 202 notifies the communication unit 201 of the failure in the setting. In this case, because the definition content indicating the failure in the setting of the internet GW router 50 is the definition content of the last setting, the apparatus management unit 202 can specify that the subject definition content is the definition content included in the set state information 255 illustrated in FIG. 13. Thus, the apparatus management unit 202 specifies from the set state information 255, the definition content of the last setting of the internet GW router 50.

Then, the apparatus management unit 202 determines whether the common definition that is also used for the communication with another user is present in the acquired definition content. If the common definition that is also used for the communication with another user is present in the specified definition content, the apparatus management unit 202 creates the definition information that cancels the definition dependent on the user except for the common definition from the definition content. In contrast, if the common definition that is also used for the communication with another user is not present in the specified definition content, the apparatus management unit 202 creates the definition information that cancels the set content including the common definition and the definition dependent on the user.

Furthermore, the apparatus management unit 202 acquires the RID of the internet GW router 50 from the set state information 255. Then, the apparatus management unit 202 acquires, from the physical router information 253, the management IP address, the login ID, the login password, and the privilege administrator password of the internet GW router 50 that has the acquired RID.

Then, the apparatus management unit 202 sends the management IP address, the login ID, the login password, the privilege administrator password of the internet GW router 50 and the created definition information to the setting unit 204 and instructs the setting unit 204 to release the setting. Thereafter, the apparatus management unit 202 receives a notification of the completion of the setting release from the setting unit 204. Then, the apparatus management unit 202 outputs the completion of the setting release to the communication unit 201.

The policy management unit 203 receives, from the apparatus management unit 202, an input of the RID of the internet GW router 50 that performs the setting. Furthermore, the policy management unit 203 receives, from the apparatus management unit 202, a request to acquire the definition content of the policy set in the internet GW router 50 that performs the setting. Then, the policy management unit 203 acquires, from the policy information 256 illustrated in FIG. 14, the definition content of the policy associated with the RID of the internet GW router 50 that performs the setting. Then, the policy management unit 203 outputs, to the apparatus management unit 202, the acquired definition content of the policy of the internet GW router 50 that performs the setting.

The setting unit 204 acquires, from the apparatus management unit 202, the management IP address, the login ID, the login password, and the privilege administrator password of the internet GW router 50 that performs the setting and the definition information. Furthermore, the setting unit 204 receives an instruction to perform the setting of the internet GW router 50 from the apparatus management unit 202. Then, the setting unit 204 logs in to the internet GW router 50 that performs the setting, sends the definition information to the internet GW router 50, and performs the setting. Thereafter, the setting unit 204 receives the execution result of the setting from the internet GW router 50 that performed the setting. Then, the setting unit 204 outputs the execution result of the setting to the apparatus management unit 202.

If the setting has normally been completed but the setting of the router 60 has failed, the setting unit 204 receives, from the apparatus management unit 202, an input of the management IP address, the login ID, the login password, and the privilege administrator password of the internet GW router 50 and an input of the definition information that releases the setting. Then, the setting unit 204 logs in to the internet GW router 50 in which the setting is to be released, sends the definition information that releases the setting to the internet GW router 50, and releases the setting. Thereafter, the setting unit 204 receives a notification of the completion of the setting release from the internet GW router 50 in which the setting has been released. Then, the setting unit 204 outputs the notification of the completion of the setting release to the apparatus management unit 202.

Furthermore, in also a case in which the setting of the internet GW router 50 has failed, the setting unit 204 receives, from the apparatus management unit 202, an input of the management IP address, the login ID, the login password, and the privilege administrator password of the internet GW router 50 and an input of the definition information that releases the setting. Then, the setting unit 204 logs in to the internet GW router 50 in which the setting is to be released, sends the definition information that releases the setting to the internet GW router 50, and releases the setting. Thereafter, the setting unit 204 receives a notification of the completion of the setting release from the internet GW router 50 in which the setting has been released. Then, the setting unit 204 outputs the notification of the completion of the setting release to the apparatus management unit 202.

The local connection environment management device 300 includes a communication unit 301, an apparatus management unit 302, a policy management unit 303, a setting unit 304, and a storage unit 305. If it is assumed that the cloud environment management device 200 is the “first setting unit”, the local connection environment management device 300 corresponds to an example of the “second setting unit”. Furthermore, if it is assumed that the cloud environment management device 200 is the “second setting unit”, the local connection environment management device 300 corresponds to an example of the “first setting unit”.

In the embodiment, the local connection environment management device 300 manages the single router 60. Thus, unlike the cloud environment management device 200, the router 60 that is set by the local connection environment management device 300 has been specified.

The storage unit 305 includes physical router information 351, definition creation information 352, set state information 353, and policy information 354.

In the physical router information 351, for example, the information having the same item as that included in the physical router information 253 illustrated in FIG. 11 is registered. In the definition creation information 352, for example, the information having the same item as that included in the definition creation information 254 illustrated in FIG. 12 is registered. In the set state information 353, for example, the information having the same item as that included in the set state information 255 illustrated in FIG. 13 is registered. In the policy information 354, for example, the information having the same item as that included in the policy information 256 illustrated in FIG. 14 is registered.

The communication unit 301 receives the VLAN ID, the LAN address, and the VRF identifier from the controller control unit 104 in the overall management device 100. Then, the communication unit 301 outputs the received VLAN ID, the LAN address, and the VRF identifier to the apparatus management unit 302.

Thereafter, the communication unit 301 receives an input of the execution result of the setting from the apparatus management unit 302. Then, the communication unit 301 sends the execution result of the setting to the controller control unit 104 in the overall management device 100.

If the setting of the router 60 has normally been completed and if the setting of the internet GW router 50 performed by the cloud environment management device 200 has failed, the communication unit 301 receives an instruction to release the setting together with the VLAN ID, the LAN address, and the VRF identifier from the controller control unit 104. Then, the communication unit 301 outputs the instruction to release the setting together with the VLAN ID, the LAN address, and the VRF identifier to the apparatus management unit 302. Thereafter, the communication unit 301 receives a notification of the completion of the setting release from the apparatus management unit 302. Then, the communication unit 301 sends the completion of the setting release to the controller control unit 104.

Furthermore, in also the case of a failure in the setting of the router 60, the communication unit 301 receives the notification of the completion of the setting release from the apparatus management unit 302. Then, the communication unit 301 sends the completion of the setting release to the controller control unit 104.

The apparatus management unit 302 receives an input of the VLAN ID, the LAN address, and the VRF identifier from the communication unit 301. Then, the apparatus management unit 302 receives the information on the model of the router 60 from the physical router information 351. Then, the apparatus management unit 302 acquires the definition content associated with the acquired information on the model from the definition creation information 352.

Then, the apparatus management unit 302 notifies the policy management unit 303 of the RID of the router 60 and requests the policy management unit 303 to acquire the definition content of the policy set in the router 60. Thereafter, the apparatus management unit 302 receives an input of the definition content of the policy set in the router 60 from the policy management unit 303.

Then, the apparatus management unit 302 creates the definition information that is used to perform the setting by using definition content that is in accordance with the model of the router 60 and by using the definition content of the policy. Thereafter, the apparatus management unit 302 acquires the management IP address, the login ID, the login password, and the privilege administrator password of the router 60 from the physical router information 351. Thereafter, the apparatus management unit 302 sends the management IP address, the login ID, the login password, and the privilege administrator password of the router 60 and the created definition information to the setting unit 304. Then, the apparatus management unit 302 instructs the setting unit 304 to perform the setting of the router 60.

Thereafter, the apparatus management unit 302 receives a notification of the execution result of the setting from the setting unit 304. If a notification of the completion of the normal setting is received from the setting unit 304, the apparatus management unit 302 notifies the communication unit 301 of the completion of the normal setting. Furthermore, the apparatus management unit 302 associates the setting information with the RID of the router 60 and registers the associated setting information in the set state information 353.

At this time, if the setting of the internet GW router 50 performed by the cloud environment management device 200 has failed, the apparatus management unit 302 receives an input of an instruction to release the setting together with the VLAN ID, the LAN address, and the VRF identifier from the communication unit 301. In this case, the apparatus management unit 302 specifies, from the definition content registered in the set state information 353, the definition content associated with the acquired VLAN ID, the LAN address, and the VRF identifier.

Furthermore, the apparatus management unit 302 determines whether the common definition that is also used for the communication with another user is present in the specified definition content. If the common definition used for the communication with the other user is present in the specified definition content, the apparatus management unit 302 creates the definition information that cancels the definition dependent on the user except for the common definition from the definition content. In contrast, if the common definition used for the communication with the other user is not present in the specified definition content, the apparatus management unit 302 creates the definition information that cancels the set content including the common definition and the definition dependent on the user.

Furthermore, the apparatus management unit 302 acquires the RID of the router 60 from the set state information 353. Then, the apparatus management unit 302 acquires, by using the acquired RID, the management IP address, the login ID, the login password, and the privilege administrator password of the router 60 from the physical router information 351.

Then, the apparatus management unit 302 sends the management IP address, the login ID, the login password, and the privilege administrator password of the router 60 and the created definition information to the setting unit 304 and instructs to release the setting. Thereafter, the apparatus management unit 302 receives a notification of the completion of the setting release from the setting unit 304. Then, the apparatus management unit 302 outputs the completion of the setting release to the communication unit 301.

In contrast, if a notification of a failure in the setting is received from the setting unit 304, the apparatus management unit 302 notifies the communication unit 301 of the failure in the setting. In this case, the apparatus management unit 302 specifies the definition content of the last setting of the router 60 from the set state information 353.

Then, the apparatus management unit 302 determines whether the common definition that is also used for the communication with another user is present in the specified definition content. If the common definition that is also used for the communication with another user is present in the specified definition content, the apparatus management unit 302 creates the definition information that cancels the definition dependent on the user except for the common definition from the definition content. In contrast, if the common definition that is also used for the communication with another user is not present in the specified definition content, the apparatus management unit 302 creates the definition information that cancels the set content including the common definition and the definition dependent on the user.

Furthermore, the apparatus management unit 302 acquires the RID of the router 60 from the set state information 353. Then, the apparatus management unit 302 acquires, by using the acquired RID, the management IP address, the login ID, the login password, and the privilege administrator password of the router 60 from the physical router information 351.

Then, the apparatus management unit 302 sends the management IP address, the login ID, the login password, and the privilege administrator password of the router 60 and the created definition information to the setting unit 304 and instructs the setting unit 304 to release the setting. Thereafter, the apparatus management unit 302 receives a notification of the completion of the setting release from the setting unit 304. Then, the apparatus management unit 302 outputs the completion of the setting release to the communication unit 301.

The policy management unit 303 receives an input of the RID of the router 60 from the apparatus management unit 302. Furthermore, the policy management unit 303 receives, from the apparatus management unit 302, a request to acquire the definition content of the policy set in the router 60. Then, the policy management unit 303 acquires the definition content of the policy associated with the RID of the router 60 from the policy information 354. Then, the policy management unit 303 outputs the acquired definition content of the policy of the router 60 to the apparatus management unit 302.

The setting unit 304 acquires the management IP address, the login ID, the login password, and the privilege administrator password of the router 60 and the definition information from the apparatus management unit 302. Furthermore, the setting unit 304 receives an instruction to perform the setting of the internet GW router 50 from the apparatus management unit 302. Then, the setting unit 304 logs in to the router 60, sends the definition information to the router 60, and performs the setting. Thereafter, the setting unit 304 receives the execution result of the setting from the router 60. Then, the setting unit 304 outputs the execution result of the setting to the apparatus management unit 302.

If the setting has normally been completed but the setting of the internet GW router 50 has failed, the setting unit 304 receives, from the apparatus management unit 302, an input of the management IP address, the login ID, the login password, and the privilege administrator password of the router 60 and an input of the definition information that releases the setting. Then, the setting unit 304 logs in to the router 60, sends the definition information that releases the setting to the router 60, and releases the setting. Thereafter, the setting unit 304 receives the completion of the setting release from the router 60. Then, the setting unit 304 outputs the completion of the setting release to the apparatus management unit 302.

Furthermore, in also a case in which the setting of the router 60 has failed, the setting unit 304 receives, from the apparatus management unit 302, an input of the management IP address, the login ID, the login password, and the privilege administrator password of the router 60 and an input of the definition information that releases the setting. Then, the setting unit 304 logs in to the router 60, sends the definition information that releases the setting to the router 60, and releases the setting. Thereafter, the setting unit 304 receives the completion of the setting release from the router 60. Then, the setting unit 304 outputs the completion of the setting release to the apparatus management unit 302.

FIG. 15 is a block diagram illustrating an internet GW router. Here, a description will be given of the internet GW router 51 as an example. The internet GW router 52 also has the same configuration. The internet GW router 51 includes a request processing unit 501, an information table 502, a routing processing unit 503, and a packet processing unit 504.

The request processing unit 501 receives the definition information from the cloud environment management device 200. Then, the request processing unit 501 stores definition information 505 in the information table 502. Furthermore, the request processing unit 501 notifies the packet processing unit 504 that the definition information 505 has been stored in the information table 502. Thereafter, the request processing unit 501 receives a notification of the execution result of the setting from the packet processing unit 504. Then, the request processing unit 501 sends the execution result of the setting to the cloud environment management device 200.

If the setting of the own device has been successful but the setting of the router 60 performed by the local connection environment management device 300 has failed, the request processing unit 501 receives the definition information that releases the setting from the cloud environment management device 200. Then, by using the definition information that releases the setting, the request processing unit 501 releases the setting designated by the definition information 505 in the information table 502. Thereafter, the request processing unit 501 sends the completion of the setting release to the cloud environment management device 200.

In also a case in which the setting of the own device has failed, the request processing unit 501 receives the definition information that releases the setting from the cloud environment management device 200. Then, by using the definition information that releases the setting, the request processing unit 501 releases the setting designated by the definition information 505 in the information table 502. Thereafter, the request processing unit 501 sends the completion of the setting release to the cloud environment management device 200.

The packet processing unit 504 receives an input of a packet used for the communication between the virtual server 701 and the user device 2 from the L2 switch 14. Then, the packet processing unit 504 outputs the header information related to the packet to the routing processing unit 503. Thereafter, the packet processing unit 504 acquires the routing information related to the packet from the routing processing unit 503. Then, the packet processing unit 504 outputs the packet to the L2 switch 14 in accordance with the acquired routing information.

Furthermore, the packet processing unit 504 receives a notification that the definition information 505 has been stored in the information table 502 from the request processing unit 501. Then, the packet processing unit 504 requests the routing information related to the communication that is performed by using the stored definition information 505 from the routing processing unit 503. Thereafter, the packet processing unit 504 verifies whether the communication performed by using the stored definition information 505 can normally be performed by using the routing information acquired form the routing processing unit 503. If the communication using the stored definition information 505 can normally be performed, the packet processing unit 504 notifies the request processing unit 501 of the completion of the normal setting. In contrast, if the communication using the stored definition information 505 is not able to normally be performed, the packet processing unit 504 notifies the request processing unit 501 of a failure in the setting.

The routing processing unit 503 acquires the header information on the packet from the packet processing unit 504. Then, the routing processing unit 503 refers to the definition information in the information table 502 and creates the routing information that is in accordance with the acquired header information. Thereafter, the routing processing unit 503 outputs the created routing information to the packet processing unit 504.

Furthermore, the router 60 has the same function as that performed by the internet GW router 51 illustrated in FIG. 15. Then, similarly to the internet GW router 51, the router 60 processes the communication packet and also processes the definition information sent from the local connection environment management device 300.

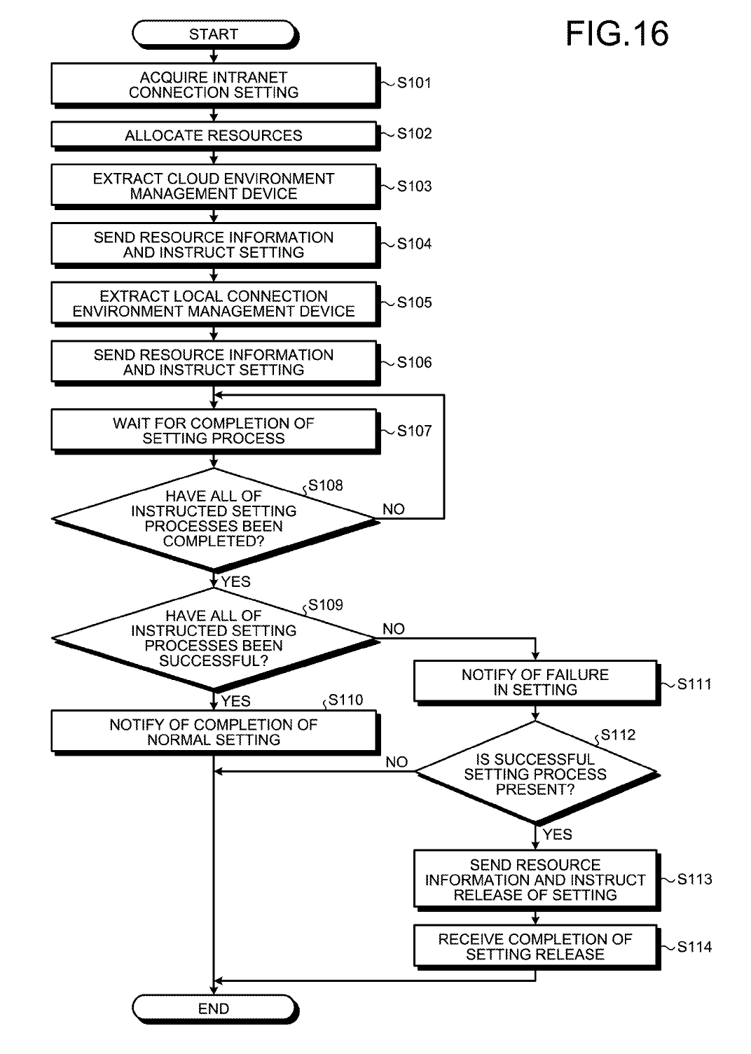

In the following, the flow of a process performed by the overall management device 100 at the time of setting the internet GW router 50 and the router 60 will be described with reference to FIG. 16. FIG. 16 is a flowchart of the process performed by the overall management device at the time of setting the physical router.

The reception unit 101 acquires the intranet connection setting including the domain ID and the virtual router ID from the user device 2 (Step S101). Then, the reception unit 101 outputs the information on the intranet connection setting to the controller management unit 102.

The controller management unit 102 receives an input of the information on the intranet connection setting from the reception unit 101. Then, the controller management unit 102 outputs the domain ID and the virtual router ID to the resource management unit 103 and instructs the resource management unit 103 to allocate the resource. The resource management unit 103 receives, from the controller management unit 102, an instruction to allocate the resource together with the domain ID and the virtual router ID. Then, the resource management unit 103 allocates the resources including the VLAN ID, the LAN address, and the VRF identifier to the domain ID and the virtual router ID (Step S102). Then, the resource management unit 103 notifies the controller management unit 102 of the information on the allocated resources.

The controller management unit 102 acquires the information on the resources allocated to the domain ID and the virtual router ID from the resource management unit 103. Furthermore, the controller management unit 102 extracts the cloud environment management device 200 from the controller information 151 (Step S103).

Then, the controller management unit 102 sends, to the extracted cloud environment management device 200, the resource information including the VLAN ID, the LAN address, and the VRF identifier together with the domain ID and the virtual router ID. Then, the controller management unit 102 instructs the cloud environment management device 200 via the controller control unit 104 to set the internet GW router 50 (Step S104).

Then, the controller management unit 102 extracts the local connection environment management device 300 from the controller information 151 (Step S105).

Then, the controller management unit 102 sends the resource information including the VLAN ID, the LAN address, and the VRF identifier to the extracted local connection environment management device 300 via the controller control unit 104. Then, the controller management unit 102 instructs the local connection environment management device 300 to set the router 60 (Step S106).

Then, the controller management unit 102 wait for the completion of the setting process of the internet GW router 50 performed by the cloud environment management device 200 and the setting process of the router 60 performed by the local connection environment management device 300 (Step S107). Here, the controller management unit 102 grasps the completion of each of the setting processes by receiving a notification of the execution result of the setting from the cloud environment management device 200 and the local connection environment management device 300 via the controller control unit 104.

The controller management unit 102 determines whether all of the instructed setting processes, i.e., the setting process of the internet GW router 50 performed by the cloud environment management device 200 and the setting process of the router 60 performed by the local connection environment management device 300 have been completed (Step S108). If an uncompleted setting process remains (No at Step S108), the controller management unit 102 returns to Step S107.

In contrast, if all of the instructed setting processes have been completed (Yes at Step S108), the controller management unit 102 determines whether all of the instructed setting process are successful (Step S109). At this time, if the controller management unit 102 receives a notification of the completion of the normal setting as the execution result of the setting, the controller management unit 102 determines that the setting process has been successful and, if the controller management unit 102 receives a notification of a failure in the setting, the controller management unit 102 determines that the setting process has failed.

If all of the instructed setting processes are successful (Yes at Step S109), the controller management unit 102 notifies an administrator of the data center 1 of the completion of the normal setting (Step S110). Then, the controller management unit 102 ends the setting process of the physical router.

In contrast, if a failed setting process is present (No at Step S109), the controller management unit 102 notifies the administrator of the data center 1 of the failure in the setting (Step S111).

Then, the controller management unit 102 determines whether a successful setting process is present (Step S112). If a successful setting process is not present (No at Step S112), the controller management unit 102 ends the setting process of the physical router.

In contrast, if a successful setting process is present (Yes at Step S112), the controller management unit 102 sends the resource information notified at the time of executing the successful setting process via the controller control unit 104. In this case, the controller management unit 102 sends the resource information to one of the devices that successfully performed the setting process between the cloud environment management device 200 and the local connection environment management device 300. Then, the controller management unit 102 instructs the device to which the resource information has been sent to release the setting (Step S113).

Then, the controller management unit 102 receives a notification of the completion of the setting release via the controller control unit 104 (Step S114). Then, the controller management unit 102 ends the setting process of the physical router.

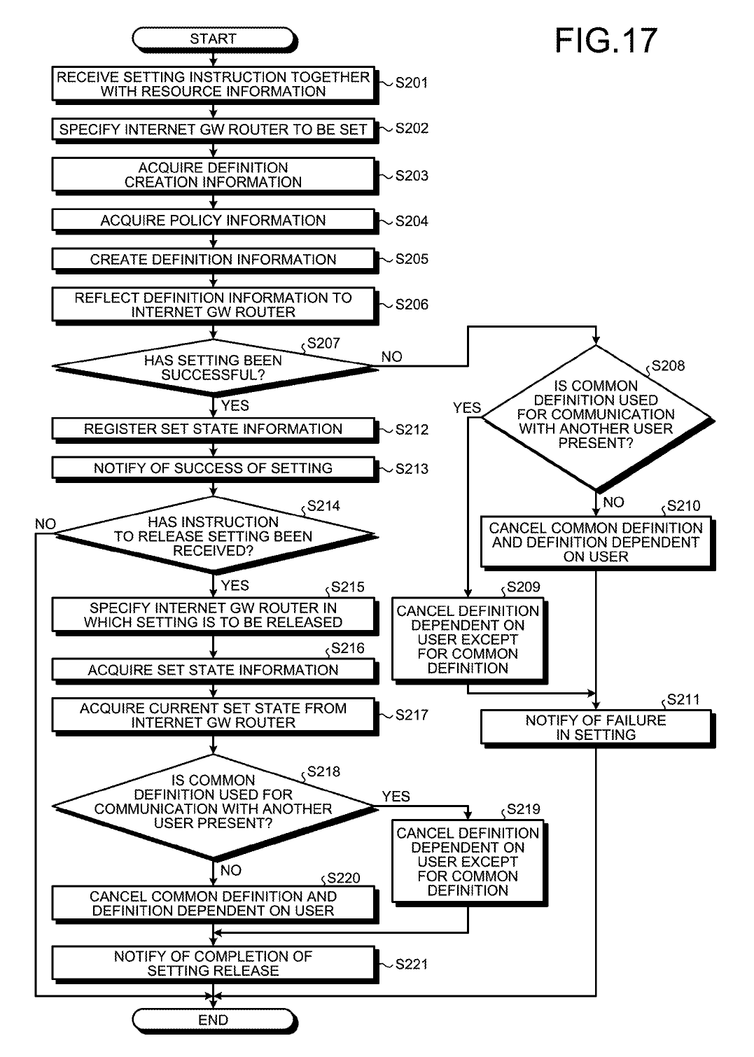

In the following, the flow of the process performed by the cloud environment management device 200 at the time of setting the internet GW router 50 will be described with reference to FIG. 17. FIG. 17 is a flowchart of the process performed by the cloud environment management device at the time of setting the physical router.

The apparatus management unit 202 receives, from the overall management device 100 via the communication unit 201, an instruction to set the internet GW router 50 together with the resource information including the domain ID and the virtual router ID as well as the VLAN ID, the LAN address, and the VRF identifier (Step S201).

Then, the apparatus management unit 202 acquires the information on the virtual server 701 and the virtual router 702 from the virtual environment management device 40 and creates the virtual router management information 251. Then, the apparatus management unit 202 specifies, by using the virtual router management information 251, the VM host 70 in which the virtual router 702 is arranged. Furthermore, the apparatus management unit 202 extracts the internet GW router 50 to which the specified VM host 70 is connected from the physical router connection information 252 and specifies the internet GW router 50 to be set (Step S202). Then, the apparatus management unit 202 acquires the information on the internet GW router 50 to be set from the physical router information 253.

Then, the apparatus management unit 202 acquires the definition content associated with the internet GW router 50 from the definition creation information 254 as the definition creation information on the internet GW router 50 (Step S203).

Furthermore, the apparatus management unit 202 requests the policy management unit 203 to acquire the policy information on the internet GW router 50. The policy management unit 203 acquires the definition content of the policy associated with the internet GW router 50 from the policy information 256 as the policy information on the internet GW router 50. Then, the apparatus management unit 202 acquires the policy information on the internet GW router 50 from the policy management unit 203 (Step S204).

Then, the apparatus management unit 202 creates the definition information on the internet GW router 50 by using the definition creation information and the policy information on the internet GW router 50 (Step S205).

Then, the apparatus management unit 202 sends the management IP address, the login ID, the login password, the privilege administrator password, and the created definition information to the setting unit 204 and instructs the setting unit 204 to set the internet GW router 50. The setting unit 204 reflects the received definition information to the internet GW router 50 (Step S206).

Thereafter, the apparatus management unit 202 acquires the execution result of the setting via the setting unit 204. Then, the apparatus management unit 202 determines, based on the acquired execution result, whether the setting of the internet GW router 50 has been successful (Step S207).

If the setting has failed (No at Step S207), the apparatus management unit 202 determines whether the common definition used for the communication with another user is present in the definition information sent to the internet GW router 50 (Step S208).

If the common definition used for the communication with another user is present (Yes at Step S208), the apparatus management unit 202 creates the definition information that cancels the definition dependent on the user except for the common definition and that releases the setting performed on the internet GW router 50. Then, the apparatus management unit 202 outputs the definition information that releases the setting to the setting unit 204. The setting unit 204 sends the definition information that releases the setting that is input from the apparatus management unit 202 to the internet GW router 50 and cancels the definition dependent on the user except for the common definition from the internet GW router 50 (Step S209). Thereafter, the apparatus management unit 202 proceeds to Step 5211.

In contrast, if the common definition used for the communication with another user is not present (No at Step S208), the apparatus management unit 202 creates the definition information that cancels the common definition and the definition dependent on the user and that releases the setting performed on the internet GW router 50. Then, the apparatus management unit 202 outputs the definition information that releases the setting to the setting unit 204. The setting unit 204 sends the definition information that is input from the apparatus management unit 202 and that releases the setting to the internet GW router 50 and cancels the common definition and the definition dependent on the user from the setting performed on the internet GW router 50 (Step S210).

Thereafter, the apparatus management unit 202 notifies the administrator of the data center 1 of the failure in the setting (Step S211).

In contrast, if the setting is successful (Yes at Step S207), the apparatus management unit 202 registers the created definition information in the set state information 255 (Step S212).

Then, the apparatus management unit 202 notifies the administrator of the data center 1 of the successful setting (Step S213).

Thereafter, the apparatus management unit 202 determines whether an instruction to release the setting is received from the overall management device 100 (Step S214). If an instruction to release the setting is not received (No at Step S214), the apparatus management unit 202 ends the setting process of the internet GW router 50.

In contrast, if an instruction to release the setting is received (Yes at Step S214), the apparatus management unit 202 searches the set state information 255 by using the VLAN ID, the LAN address, and the VRF identifier notified from the overall management device 100. Then, the apparatus management unit 202 specifies the internet GW router 50 in which the setting is to be released (Step S215).

Then, the apparatus management unit 202 acquires, from the set state information 255, the definition content that is the set state information on the internet GW router 50 in which the setting it to be released (Step S216).

Furthermore, the apparatus management unit 202 acquires the current set state from the internet GW router 50 via the setting unit 204 (Step S217).

Then, the apparatus management unit 202 determines whether the common definition that is used for the communication with another user is present in the portion associated with the definition content that indicates the release and that is included in the current set state (Step S218).

If the common definition used for the communication with another user is present (Yes at Step S218), the apparatus management unit 202 creates the definition information that cancels definition dependent on the user except for the common definition and that releases the setting performed on the internet GW router 50. Then, the apparatus management unit 202 outputs the definition information that releases the setting to the setting unit 204. The setting unit 204 sends the definition information that is input from the apparatus management unit 202 and that releases the setting to the internet GW router 50 and cancels the definition dependent on the user except for the common definition from the setting of the internet GW router 50 (Step S219). Thereafter, the apparatus management unit 202 proceeds to Step S221.

In contrast, if the common definition used for the communication with another user is not present (No at Step S218), the apparatus management unit 202 creates the definition information that cancels the common definition and the definition dependent on the user and that releases the setting performed on the internet GW router 50. Then, the apparatus management unit 202 outputs the definition information that releases the setting to the setting unit 204. The setting unit 204 sends the definition information that is input from the apparatus management unit 202 and that releases the setting to the internet GW router 50 and cancels the common definition and the definition dependent on the user from the setting performed on the internet GW router 50 (Step S220).

Thereafter, the apparatus management unit 202 notifies the administrator of the data center 1 of the completion of the setting release (Step S221).

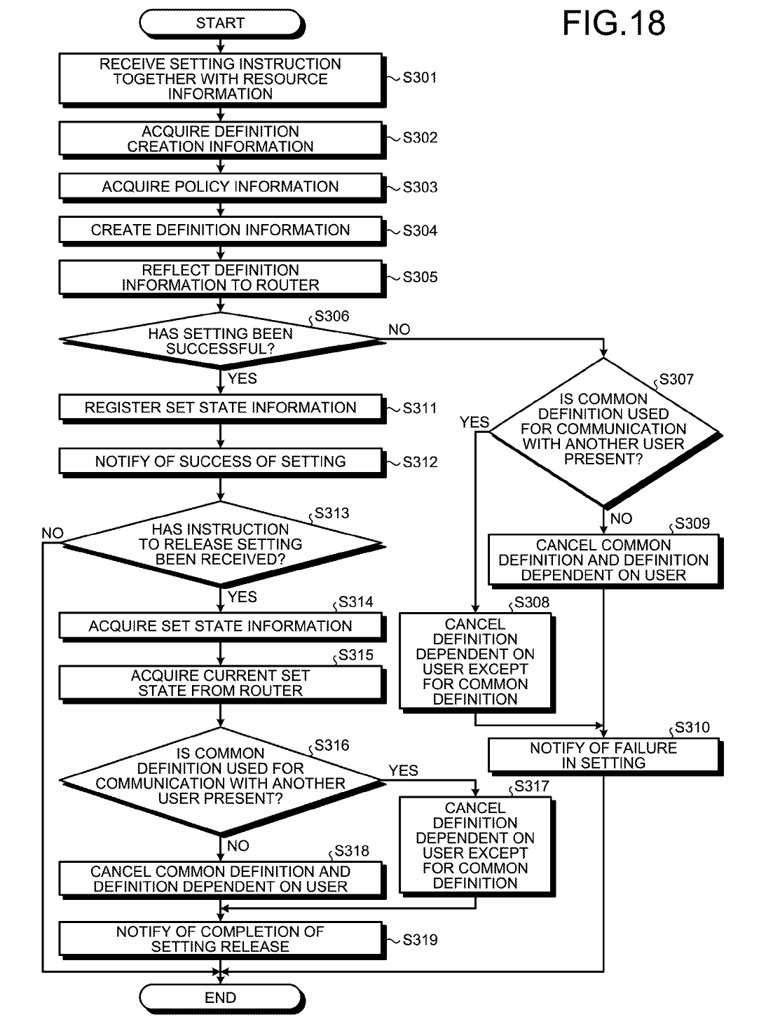

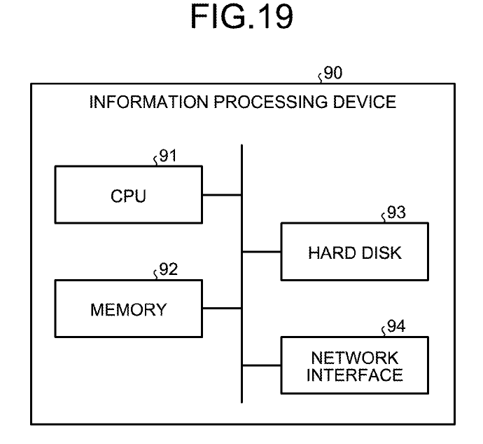

In the following, the flow of the process performed by the local connection environment management device 300 at the time of setting the router 60 will be described with reference to FIG. 18. FIG. 18 is a flowchart of the process performed by the local connection environment management device at the time of setting the physical router.

The apparatus management unit 302 receives an instruction to set the router 60 together with the resource information including the VLAN ID, the LAN address, and the VRF identifier from the overall management device 100 via the communication unit 301 (Step S301). Then, the apparatus management unit 302 acquires the information on the router 60 from the physical router information 351.

Then, the apparatus management unit 302 acquires the definition content associated with the router 60 from the definition creation information 352 as the definition creation information on the router 60 (Step S302).

Furthermore, the apparatus management unit 302 requests the policy management unit 303 to acquire the policy information on the router 60. The policy management unit 303 acquires the definition content of the policy associated with the router 60 from the policy information 354 as the policy information on the router 60. Then, the apparatus management unit 302 acquires the policy information on the router 60 from the policy management unit 303 (Step S303).

Then, the apparatus management unit 302 creates the definition information on the router 60 by using the definition creation information and the policy information on the router 60 (Step S304).

Then, the apparatus management unit 302 sends the management IP address, the login ID, the login password, the privilege administrator password and the created definition information to the setting unit 304 and instructs the setting unit 304 to set the router 60. The setting unit 304 reflects the received definition information to the router 60 (Step S305).

Thereafter, the apparatus management unit 302 acquires the execution result of the setting via the setting unit 304. Then, the apparatus management unit 302 determines, based on the acquired execution result, whether the setting of the router 60 is successful (Step S306).

If the setting has failed (No at Step S306), the apparatus management unit 302 determines whether the common definition used for the communication with another user is present in the definition information sent to the router 60 (Step S307).

If the common definition used for the communication with another user is present (Yes at Step S307), the apparatus management unit 302 creates the definition information that cancels the definition dependent on the user except for the common definition and that releases the setting performed on the router 60. Then, the apparatus management unit 302 outputs the definition information that releases the setting to the setting unit 304. The setting unit 304 sends the definition information that is input from the apparatus management unit 302 and that releases the setting to the router 60 and cancels the definition dependent on the user except for the common definition from the setting performed on the router 60 (Step S308). Thereafter, the apparatus management unit 302 proceeds to Step S310.

In contrast, if the common definition used for the communication with another user is not present (No at Step S307), the apparatus management unit 302 creates the definition information that cancels the common definition and the definition dependent on the user and that releases the setting performed on the router 60. Then, the apparatus management unit 302 outputs the definition information that releases the setting to the setting unit 304. The setting unit 304 sends the definition information that is input from the apparatus management unit 302 and that releases the setting to the router 60 and cancels the common definition and the definition dependent on the user from the setting performed on the router 60 (Step S309).

Thereafter, the apparatus management unit 302 notifies the administrator of the data center 1 of the failure in the setting (Step S310).

In contrast, if the setting is successful (Yes at Step S306), the apparatus management unit 302 registers the created definition information in the set state information 353 (Step S311).

Then, the apparatus management unit 302 notifies the administrator of the data center 1 of the successful setting (Step S312).

Thereafter, the apparatus management unit 302 determines whether an instruction to release the setting is received from the overall management device 100 (Step S313). If an instruction to release the setting is not received (No at Step S313), the apparatus management unit 302 ends the setting process on the router 60.

In contrast, if an instruction to release the setting is received (Yes at Step S313), the apparatus management unit 302 searches the set state information 353 by using the VLAN ID, the LAN address, and the VRF identifier notified from the overall management device 100. Then, the apparatus management unit 302 acquires the definition content that is the set state information on the router 60 from the set state information 353 (Step S314).

Furthermore, the apparatus management unit 302 acquires the current set state from the router 60 via the setting unit 304 (Step S315).

Then, the apparatus management unit 302 determines whether the common definition used for the communication with another user is present in the portion associated with the definition content to be released included in the current set state (Step S316).

If the common definition used for the communication with another user is present (Yes at Step S316), the apparatus management unit 302 creates the definition information that cancels the definition dependent on the user except for the common definition and that releases the setting performed on the router 60. Then, the apparatus management unit 302 outputs the definition information the releases the setting to the setting unit 304. The setting unit 304 sends the definition information that is input from the apparatus management unit 302 and that releases the setting to the router 60 and cancels the definition dependent on the user except for the common definition from the setting performed on the router 60 (Step S317). Thereafter, the apparatus management unit 302 proceeds to Step S319.

In contrast, if the common definition used for the communication with another user is not present (No at Step S316), the apparatus management unit 302 creates the definition information that cancels the common definition and the definition dependent on the user and that releases the setting performed on the router 60. Then, the apparatus management unit 302 outputs the definition information that releases the setting to the setting unit 304. The setting unit 304 sends the definition information that is input from the apparatus management unit 302 and that releases the setting to the router 60 and cancels the common definition and the definition dependent on the user from the router 60 (Step S318).

Thereafter, the apparatus management unit 302 notifies the administrator of the data center 1 of the completion of the setting release (Step S319).

In the description above, a case in which the single router 60 is present as the physical router managed by the local connection environment management device 300 has been described; however, a plurality number of the routers 60 may also be present. I such a case, the local connection environment management device 300 may also select the router 60 at the time of setting and performs the setting on the selected router 60. Then, at the time of setting release, the local connection environment management device 300 may also specify the router 60 from the set state information 353 and release the setting.

Hardware configuration

In the following, the hardware configuration of the overall management device 100, the cloud environment management device 200, and the local connection environment management device 300 will be described with reference to FIG. 19. FIG. 19 is a diagram illustrating a hardware configuration of an information processing device used as the overall management device, the cloud environment management device, and the local connection environment management device.

A commonly used information processing device 90 illustrated in, for example, FIG. 19 may be used for the overall management device 100, the cloud environment management device 200, and the local connection environment management device 300. The information processing device 90 includes a central processing unit (CPU) 91, a memory 92, a hard disk 93, and a network interface 94.

For example, in a case of the overall management device 100, the network interface 94 is an interface for performing communication with the user device 2, the cloud environment management device 200, and the local connection environment management device 300.

The hard disk 93 implements the function of the storage unit 105 illustrated in FIG. 3. Furthermore, the hard disk 93 stores therein various kinds of programs including the program used to implement the function of the reception unit 101, the controller management unit 102, the resource management unit 103, and the controller control unit 104 exemplified in FIG. 3.

The CPU 91 reads various kinds of programs from the hard disk 93, loads the programs in the memory 92, and executes the programs, thereby implementing the function of the reception unit 101, the controller management unit 102, the resource management unit 103, and the controller control unit 104 exemplified in FIG. 3.

Furthermore, in a case of the cloud environment management device 200, the network interface 94 is an interface for performing communication with the virtual environment management device 40, the internet GW router 50, and the overall management device 100.

The hard disk 93 implements the function of the storage unit 205 exemplified in FIG. 3. Furthermore, the hard disk 93 stores therein various kinds of programs including the program used to implement the function of the communication unit 201, the apparatus management unit 202, the policy management unit 203, and the setting unit 204 exemplified in FIG. 3.

The CPU 91 reads various kinds of programs from the hard disk 93 and loads the programs in the memory 92, thereby implementing the function of the communication unit 201, the apparatus management unit 202, the policy management unit 203, and the setting unit 204 exemplified in FIG. 3.

Furthermore, in a case of the local connection environment management device 300, the network interface 94 is an interface for performing communication with the router 60 and the overall management device 100.

The hard disk 93 implements the function of the storage unit 305 exemplified in FIG. 3. Furthermore, the hard disk 93 stores therein various kinds of programs including the program used to implement the function of the communication unit 301, the apparatus management unit 302, the policy management unit 303, and the setting unit 304 exemplified in FIG. 3.

The CPU 91 reads various kinds of programs from the hard disk 93 and loads the programs in the memory 92, thereby implementing the function of the communication unit 301, the apparatus management unit 302, the policy management unit 303, and the setting unit 304 exemplified in FIG. 3.

As described above, when the data center according to the embodiment performs a setting of a network apparatus arranged on a cloud service environment side and a setting of a network apparatus arranged on a local connection environment side, if one of the settings failed, the data center cancels the failed setting from both the network apparatuses. Consequently, it is possible to reduce the occurrence of inconsistency of the set state between the network apparatuses. Accordingly, it is possible to reduce the degradation of the performance of the network apparatuses due to the occurrence of a useless packet and thus improve the quality of the providing service. Furthermore, it is possible to reduce the occurrence of alarm logs or error logs of the network apparatus and reduce a disappearance of an important log and it is possible to easily search an important log. Accordingly, it is possible to improve the quality of the providing service.

On this point, it is conceivable to use a method in which each of the management devices stores therein a previous state at the time of setting performed on each network apparatus and returns, if the setting of the network apparatus performed by own device has been successful but the setting of the other network apparatus has failed, the own network apparatus to the previous state that is before the setting. However, it is conceivable that, in the network apparatus, various settings with respect to various kinds of communication is performed one after another; therefore, if the state is simply returned to the state before the setting, the setting of the other communication performed after the setting is also canceled. In this case, inconsistency may possibly occur with another network apparatus or it takes some time and effort to set the network again. In contrast, in the data center according to the embodiment described above, the executed set content is stored and only the executed set content is canceled. Consequently, it is possible to appropriately release the setting.

Furthermore, in the data center according to the embodiment, when a setting is released, if the common definition that is used by communication with another user is present, the setting is released by leaving the common definition. Consequently, the setting can be released without affecting the communication with the other user.

According to an aspect of an embodiment, the present invention can provide the information processing device, the communication control method, and the communication control program that improve the quality of the providing service.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing device comprising:
a first communication apparatus and a second communication apparatus;
a management unit that decides communication setting information on each of the first communication apparatus and the second communication apparatus;
a first setting unit that performs a first setting on the first communication apparatus based on the communication setting information decided by the management unit and that cancels, when the first setting has failed, the first setting performed on the first communication apparatus; and
a second setting unit that performs a second setting on the second communication apparatus based on the communication setting information decided by the management unit and that cancels, when the first setting unit has failed the first setting, the second setting performed on the second communication apparatus.

2. The information processing device according to claim 1, wherein
the first setting unit notifies the management unit of the failure in the first setting,
when the management unit receives the notification of the failure in the first setting, the management unit notifies the second setting unit of specific information that is used to specify the second setting, and
the second setting unit specifies the second setting based on the specific information notified by the management unit and cancels the second setting performed on the second communication apparatus.

3. The information processing device according to claim 2, wherein
the management unit notifies the second setting unit of the communication setting information as the specific information, and
the second setting unit cancels the second setting by cancelling the setting related to the communication setting information.

4. The information processing device according to claim 1, wherein, when a common portion common to another setting is present in the first setting and the second setting, the first setting unit and the second setting unit cancel the setting other than the common portion in the first setting and the second setting, respectively.

5. A communication control method performed by an information processing device including a first communication apparatus and a second communication apparatus, the communication control method comprising:
deciding communication setting information on each of the first communication apparatus and the second communication apparatus;
performing a first setting on the first communication apparatus based on the decided communication setting information;
performing a second setting on the second communication apparatus based on the decided communication setting information; and
cancelling, when the first setting has failed, the first setting performed on the first communication apparatus and cancelling the second setting performed on the second communication apparatus.

6. A non-transitory computer-readable recording medium having stored therein a communication control program for an information processing device including a first communication apparatus and a second communication apparatus, the communication control program that causes a computer to execute a process comprising:
deciding communication setting information on each of the first communication apparatus and the second communication apparatus;
performing a first setting on the first communication apparatus based on the decided communication setting information;
performing a second setting on the second communication apparatus based on the decided communication setting information; and
cancelling, when the first setting has failed, the first setting performed on the first communication apparatus and cancelling the second setting performed on the second communication apparatus.
